(19) United States
(12) Patent Application Publication
(10) Pub. No.: US 2006/0075831 A1
(43) Pub. Date: Apr. 13, 2006

(54) Surface pressure distribution sensor

(75) Inventor: Nobuyuki Okuda, Miyagi-ken (JP)

Correspondence Address: BEYER WEAVER & THOMAS LLP, P.O. BOX 70250, OAKLAND, CA, 94612-0250, US

(73) Assignee: ALPS ELECTRIC CO., LTD.

(21) Appl. No.: 11/228,070

(22) Filed: Sep. 15, 2005

(30) Foreign Application Priority Data
Oct. 13, 2004 (JP) 2004-298405

(51) Int. Cl. G01D 7/00

(52) U.S. Cl. 73/862.046

(57) ABSTRACT

A fluid collecting section is provided beside a measuring section, and an inner space of the fluid collecting section communicates with an inner space of the measuring section. Therefore, when the inner space of the measuring section is collapsed by pressing a measuring surface, fluid can escape toward the fluid collecting section. Consequently, the increase in internal pressure of the inner space of the measuring section is limited, and the upward force applied to an upper substrate in the measuring section is reduced. As a result, measurement sensitivity increases.

### BACKGROUND OF THE INVENTION

1. Field of the Invention

The present invention relates to a surface pressure distribution sensor for detecting fine irregularities on an object such as a fingerprint, and more particularly, to a surface pressure distribution sensor that can improve detection sensitivity.

2. Description of the Related Art

There have been known various types of fingerprint sensors, for example, pressure-sensitive sensors, optical sensors, and semiconductor sensors (an image of a fingerprint is read on the basis of a change in the amount of charge collecting between the fingerprint and an electrode). Optical and semiconductor sensors may be incapable of properly detecting the fingerprint image depending on the state of the finger, for example, the degree of wetting. In contrast, pressure-sensitive sensors are not easily influenced by the state of the finger, and can properly detect the fingerprint image even under severe conditions. Therefore, the pressure-sensitive sensors are regarded as promising.

FIG. 7 is a partial sectional view of a pressure-sensitive fingerprint sensor disclosed in Japanese Unexamined Patent Application Publication No. 11-155837.

In the pressure-sensitive fingerprint sensor shown in FIG. 7, a plurality of lower conductors 2 extending in the Y-direction (lengthwise direction) are arranged in parallel on a lower substrate 1. An insulating layer 9 is provided on the lower conductors 2. A flexible upper substrate 3 is provided above the lower substrate 1 with a predetermined space therebetween. A plurality of upper conductors 4 extending in the direction orthogonal to the lower conductors 2 (in the X-direction) are arranged in parallel in the Y-direction on a lower surface of the upper substrate 3.

A spacer layer 5 is provided between the lower substrate 1 and the upper substrate 3. A frame 7 is provided on the upper substrate 3 to define a measuring section 6. The upper surface of the upper substrate 3 is partly exposed inside the frame 7.

When the upper substrate 3 is pressed in the direction of arrow A (opposite to the Z-direction) by a finger F placed on the upper substrate 3 in the measuring section 6, it easily bends downward because of its flexibility.

The upper substrate 4 bends correspondingly to an uneven shape 8 of a fingerprint on the finger F, and the distances between the lower conductors 2 and the upper conductors 4 are made different among the intersections thereof. By detecting changes of electrostatic capacitances in accordance with the distances, the uneven shape 8 of the fingerprint can be output as fingerprint data.

However, the above-described pressure-sensitive fingerprint sensor has the following problems.

An inner space B between the lower substrate 1 and the upper substrate 3 in the measuring section 6 is surrounded by the spacer layer 5. For example, side walls 5a of the spacer layer 5 and side walls 7a of the frame 7 are almost aligned with each other in the Z-direction.

When the upper substrate 3 is pressed in the A-direction with the finger F inside the measuring section 6, the internal pressure of the inner space B increases.

In this case, air in the inner space B escapes sideward, as shown by arrows C and D, and pushes the flexible upper substrate 3 upward. As a result, portions F1 and F2 of the fingerprint of the finger F cannot be detected properly.

The above publication discloses the structure of the pressure-sensitive fingerprint sensor, but does not refer to the problem regarding the change in internal pressure and a solution to the problem.

### SUMMARY OF THE INVENTION

Accordingly, it is an object of the present invention to provide a surface pressure distribution sensor that overcomes the above problem of the related art, that limits the change in internal pressure, and that enhances measurement sensitivity.

A surface pressure distribution sensor according to an aspect of the present invention includes a lower substrate, a plurality of lower conductors arranged in parallel on an upper surface of the lower substrate, a flexible upper substrate provided above the lower substrate with a predetermined space therebetween, and a plurality of upper conductors arranged in parallel on a lower surface of the upper substrate so as to be orthogonal to the lower conductors. A measuring section having a first inner space is provided so that the upper conductors and the lower conductors oppose in a thickness direction therein, and a fluid collecting section having a second inner space is disposed beside the measuring section. The surface pressure distribution is detected on the basis of an electrostatic capacitance changed by the pressing of a measuring surface provided on the upper substrate in the measuring section, and the first inner space of the measuring section communicates with the second inner space of the fluid collecting section.

In the present invention, the fluid collecting section is provided beside the measuring section, and the inner space of the fluid collecting section communicates with the inner space of the measuring section, as described above. Therefore, when the inner space of the measuring section is collapsed by pressing the measuring surface, fluid can escape toward the fluid collecting section. Consequently, the increase in internal pressure of the inner space of the measuring section is limited, compared with the related art, and the upward force applied to the upper substrate in the measuring section is reduced. As a result, measurement sensitivity can be increased.

Preferably, the surface pressure distribution sensor further includes a defining means provided between the lower substrate and the upper substrate, and a space connecting section for connecting the first inner space of the measuring section and the second inner space of the fluid collecting section. The defining means defines a side wall of the first inner space, a side wall of the second inner space, and a wall of the space connecting section. This allows the fluid collecting section and the space connecting section to be formed with a simple structure.

Preferably, a plastic member is provided on at least one of upper and lower surfaces of the fluid collecting section, and the fluid collecting section has a pressure adjusting function of artificially adjusting the internal pressure of the first inner space of the measuring section by pressing the surface having the plastic member to collapse the second inner space.

In a case in which the total inner space is excessively enlarged by the fluid collecting section communicating with the first inner space of the measuring section, even when the measuring surface is pressed, the internal pressure of the first inner space is too low, and it may be difficult to deform the upper substrate, for example, correspondingly to the uneven shape of the fingerprint of the finger. In this case, the uneven shape of the fingerprint cannot be detected properly. This state in which the internal pressure of the first inner space of the measuring section is too low is undesirable. In the present invention, the fluid collecting section has a pressure adjusting function in order to solve this problem. That is, the plastic member is provided on the upper or lower surface of the fluid collecting section, and the surface having the plastic member is pressed by a predetermined amount to compress the second inner space of the fluid collecting section. This increases the internal pressure of the first inner space of the measuring section, and artificially and properly adjusts the internal pressure. Since the plastic member does not easily return to its original shape after deformation, even when fluid is guided into the second inner space of the fluid collecting section by the pressing of the measuring surface, the fluid collecting section remains in the collapsed state. Therefore, the internal pressure of the first inner space of the measuring section can be kept moderate during measurement. In this way, the pressure adjusting function of the fluid collecting section permits artificial adjustment of the internal pressure of the first inner space of the measuring section, and increases measurement sensitivity.

Preferably, the fluid collecting section includes a plurality of fluid collecting sections, and at least one of the fluid collecting sections has the pressure adjusting function. When at least one of the fluid collecting sections has the pressure adjusting function, and the other of the fluid collecting sections functions as a space into which fluid flows when the measuring surface is pressed, the measurement sensitivity of the surface pressure distribution sensor can be increased further.

Preferably, each of the first and second inner spaces is an air layer. Since air is compressible, when the measuring surface is pressed, air in the first inner space of the measuring section is compressed and flows into the fluid collecting section. This can suppress the increase in internal pressure of the inner space. Consequently, when the inner space is an air layer, enhancement of measuring sensitivity by the fluid collecting section can be performed properly.

### BRIEF DESCRIPTION OF THE DRAWINGS

FIG. 1 is a partial plan view of a pressure-sensitive fingerprint sensor according to a first embodiment of the present invention;

FIG. 2 is a partial sectional view of the fingerprint sensor, taken along line II-II and viewed from the direction of arrows in FIG. 1;

FIG. 3 is an enlarged partial sectional view of the fingerprint sensor shown in FIG. 2, showing a state in which fingerprint measurement is being made;

FIG. 4 is an enlarged partial sectional view explaining a problem to be solved by the embodiment of the present invention;

FIG. 5 is an enlarged partial sectional view explaining a pressure adjusting function of the fingerprint sensor for solving the problem shown in FIG. 4;

FIG. 6 is a partial plan view of a pressure-sensitive fingerprint sensor according to a second embodiment of the present invention; and

FIG. 7 is a partial sectional view of a known pressure-sensitive fingerprint sensor.

### DESCRIPTION OF THE PREFERRED EMBODIMENTS

A first embodiment of the present invention will be described below with reference to the drawings.

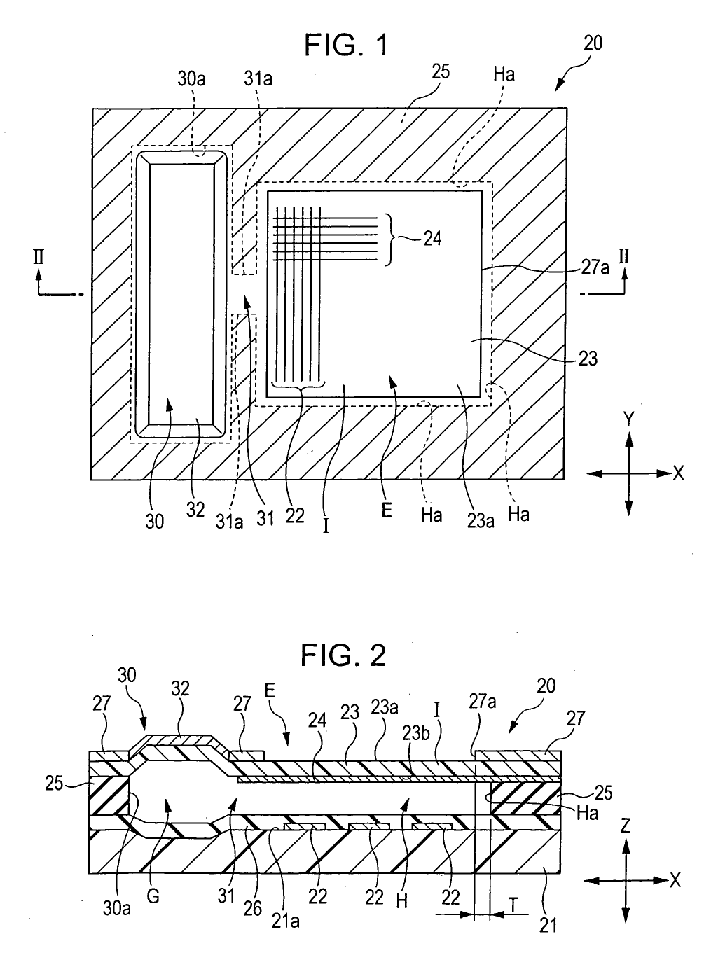

Referring to FIGS. 1 and 2, a fingerprint sensor 20 according to the first embodiment of the present invention includes a lower substrate 21, multiple lower conductors 22 arranged in parallel on an upper surface 21a of the lower substrate 21 in the widthwise direction (X-direction in the figures), an upper substrate 23, multiple upper conductors 24 arranged in parallel on a lower surface 23b of the upper substrate 23 in the lengthwise direction (Y-direction in the figures) orthogonal to the lower conductors 22, and a spacer layer 25 interposed as a defining means between the lower substrate 21 and the upper substrate 23.

The lower substrate 21 is made of, for example, glass. The lower substrate 21 may be provided integrally with the upper substrate 23. In this case, the lower substrate 21 is made of, for example, a flexible resin film.

The upper substrate 23 is made of a flexible resin film such as a PET resin film, a polyimide resin film, or a polyester film, and has a thickness of approximately 1 μm to 30 μm.

The lower conductors 22 and the upper conductors 24 are respectively formed on the upper surface 21a of the lower substrate 21 and the lower surface 23b of the upper substrate 23 by screen printing or other methods. For example, the number of the lower conductors 22 and the number of the upper conductors 24 are each approximately 200, and the pitch thereof is 50 μm.

The spacer layer 25 is made of an organic insulating material such as a resist or an adhesive, and has a thickness of approximately 25 μm.

As shown in FIG. 2, the lower conductors 22 are covered with an insulating layer 26. Alternatively, the insulating layer 26 may be provided to cover the upper conductors 24. It is satisfactory as long as the insulating layer 26 covers the surface of at least one of each lower conductor 22 and each upper conductor 24. The material of the insulating layer 26 is, for example, Si₃N₄.

A measuring section E is provided in a region having an inner space H that is defined by the upper substrate 23 and the lower substrate 21 disposed at a predetermined distance from each other so that the upper conductors 24 and the lower conductors 22 oppose in the thickness direction (Z-direction in the figures). A frame 27 is provided on the upper substrate 23 to define a measuring surface I of the measuring section E. A portion of an upper surface 23a of the upper substrate 23 exposed from the frame 27 serves as the measuring surface I. The measuring surface I is substantially rectangular.

A fluid collecting section 30 is provided at a predetermined distance from the left side of the measuring section E. As shown in FIG. 2, the fluid collecting section 30 has an inner space G sandwiched between the lower substrate 21 and the upper substrate 23. The inner space G of the fluid collecting section 30 communicates with the inner space H of the measuring section E through a space connecting section 31 sandwiched between the upper substrate 23 and the lower substrate 21.

In the fluid collecting section 30, the lower substrate 21 is slightly recessed, and the upper substrate 23 slightly protrudes upward, so that the height of the inner space G (in the Z-direction) is larger than the height of the inner space H of the measuring section E. An air layer is provided inside each of the inner spaces G and H and the space connecting section 31.

As shown in FIG. 2, the frame 27 is not provided on the upper substrate 23 in the fluid collecting section 30. That is, the frame 27 is provided on the upper substrate 23 except on the portion of the upper surface 23a serving as the measuring surface I of the measuring section E and except on a portion of the upper surface 23a that defines the fluid collecting section 30. A plastic member 32 is disposed on the portion of the upper surface 23a that defines the rectangular fluid collecting section 30.

For example, the plastic member 32 is made of a plastic metal such as stainless steel. The plastic member 32 is deformed by a pressing force, and does not return to its original shape even after the pressing force is removed.

The spacer layer 25 is provided in a diagonally shaded region shown in FIG. 1. The spacer layer 25 defines side walls Ha of the inner space H of the measuring section E, side walls 30a of the inner space G of the fluid collecting section 30, and side walls 31a of the space connecting section 31. As shown in FIG. 1, the distance between the side walls 31a of the space connecting section 31 is smaller than the distance between the side walls of the fluid collecting section 30 and the distance between the side walls of the measuring section E, as viewed from the same direction.

Side walls 27a of the frame 27, which outlines the measuring surface I of the measuring section E, are not aligned with the side walls Ha of the inner space H in the thickness direction (Z-direction) in the measuring section E. The side walls Ha of the inner space H lie under the frame 27, and the area of the inner space H is larger than the area of the measuring surface I. The width T between the side walls Ha of the inner space H and the side walls 27a of the frame 27 is approximately 1 mm to 5 mm.

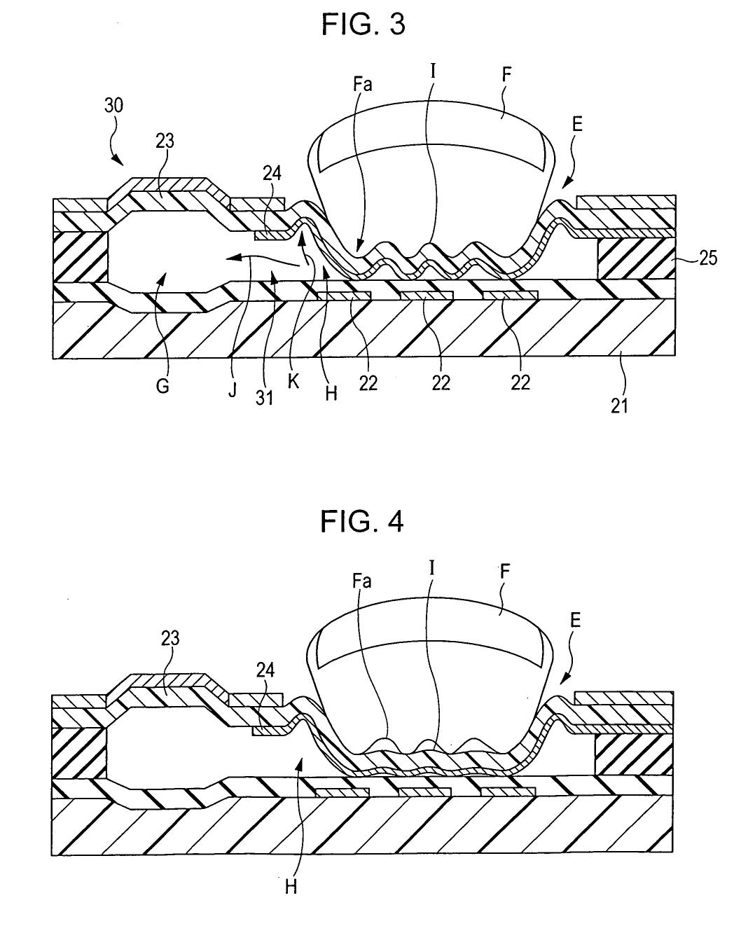

When the flexible upper substrate 23 is pressed down by a finger F placed on the measuring surface I, as shown in FIG. 3, it bends together with the upper conductors 24. In this case, the upper substrate 23 and the upper conductors 24 bend correspondingly to an uneven shape Fa of a fingerprint of the finger F. When the upper substrate 23 and the upper conductors 24 bend in this way, the distances between the upper conductors 24 and the lower conductors 22 are made different among multiple intersections of the conductors. A capacitance detector (not shown) detects changes in electrostatic capacitance depending on the distances, and outputs the uneven shape Fa of the fingerprint as signal data.

In the present invention, the fluid collecting section 30 having the inner space G is provided beside the measuring section E. The measuring section E and the fluid collecting section 30 communicates with each other through the space connecting section 31 to enlarge the total inner space of the fingerprint sensor 20. Therefore, when the measuring surface I is pressed with the finger F, air in the inner space H of the measuring section E escapes into the inner space G of the fluid collecting section 30, as shown by arrow J in FIG. 3. The increase in pressure in the inner space H is smaller than before, and an air flow in the direction of arrow K, which is produced by the increase in internal pressure and which pushes up the upper substrate 23 in the measuring section E, is reduced. As a result, when the measuring surface I is pressed with the finger F, the entire portion of the upper substrate 23 in contact with the finger F is properly pushed down correspondingly to the uneven shape Fa of the fingerprint. Accordingly, it is possible to read the uneven shape Fa of the fingerprint more widely than before, and to improve measurement sensitivity.

The fluid collecting section 30 also serves to artificially adjust the internal pressure of the measuring section E.

In a case in which the total inner space is excessively enlarged by connecting the inner space H of the measuring section E and the inner space G of the fluid collecting section 30, even when the measuring surface I is pressed, the internal pressure of the inner space H sometimes remains too low. FIG. 4 illustrates a problem caused in this case. In a case in which the internal pressure of the inner space H is too low, even when the upper substrate 23 and the upper conductors 24 are bent by pressing the measuring surface I with the finger F, they do not easily deform correspondingly to the uneven shape Fa of the fingerprint of the finger F. As a result, it may be impossible to properly detect the uneven shape Fa. In this way, it is undesirable that the internal pressure of the inner space H of the measuring section E is too low during pressing.

Accordingly, in the present invention, the plastic member 32 is provided on the portion of the upper surface 23a of the upper substrate 23 that constitutes the fluid collecting section 30, as shown in FIG. 3, so that the internal pressure of the inner space H of the measuring section E can be artificially adjusted by pressing the plastic member 32.

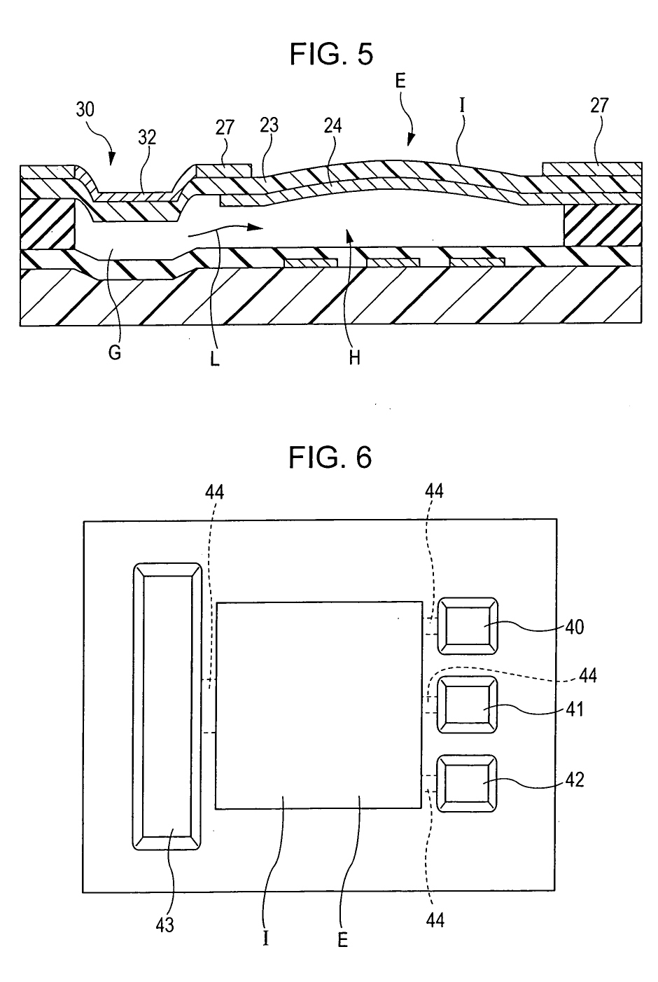

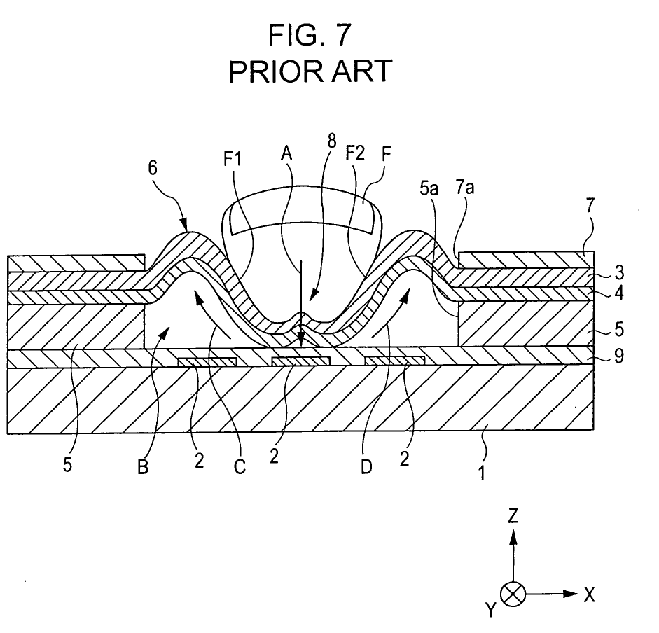

The upper surface of the fluid collecting section 30 is pressed down, for example, with a finger, as shown in FIG. 5. The plastic member 32 is thereby depressed, and air in the inner space G of the fluid collecting section 30 is guided into the inner space H of the measuring section E, as shown by arrow L. Consequently, the upper substrate 23 and the upper conductors 24 are slightly pushed up in the measuring section E. The internal pressure of the measuring section E is increased by the entry of air from the fluid collecting section 30.

When the measuring surface I is pressed with the finger F, as shown in FIG. 5, in a state in which the internal pressure of the inner space H of the measuring section E is higher than in the state shown in FIG. 2, part of air in the inner space H escapes into the inner space G of the fluid collecting section 30, as shown by arrow J, in a manner similar to that in FIG. 3. While the internal pressure of the inner space G is thereby increased, the plastic member 32 will not be pushed back to its original state by the pressure. In this case, the plastic member 32 may be slightly pushed back. Since the air in the inner space H partly thus escapes into the inner space G, the internal pressure of the inner space H does not become so higher than in the initial state shown in FIG. 5, and is kept moderate. Therefore, the upper substrate 23 and the upper conductors 24 easily and properly bend and deform correspondingly to the uneven shape Fa of the fingerprint of the finger F, and the uneven shape Fa can be reflected as a clearer image.

While it is preferable that the inner space H of the measuring section E, the inner space G of the fluid collecting section 30, and the space connecting section 31 contain air, they may contain liquid.

Since air is compressible, when the measuring surface I is pressed down with the finger F, as shown in FIG. 3, air in the inner space H of the measuring section E can move to the inner space G of the fluid collecting section 30 in a compressed state. Therefore, when the inner space is formed of an air layer, enhancement of the measurement sensitivity can be properly achieved by enlarging the inner space. Even if the inner space contains liquid, when the plastic member 32 is not provided on the upper surface of the fluid collecting section 30 and the flexible upper substrate 23 is exposed on the upper surface of the fluid collecting section 30, the liquid pushes and bends up the upper substrate 23 at the pressing of the measuring surface I with the finger F. As a result, the liquid flows from the inner space H into the inner space G, and the increase in pressure in the inner space H can be limited.

FIG. 6 is a partial plan view of a fingerprint sensor according to a second embodiment of the present invention. As shown in FIG. 6, the fingerprint sensor includes a measuring section E, and four fluid collecting sections 40, 41, 42, and 43. The fluid collecting sections 40 to 43 are respectively connected to the measuring section E by corresponding space connecting sections 44. Each of the three small fluid collecting sections 40, 41, and 42 disposed on the right side of the measuring section E has a plastic member 32 on its upper surface, and serves to artificially adjust the internal pressure of an inner space H of the measuring section E, in a manner similar to that in the fluid collecting section 30 shown in FIG. 1. In the second embodiment, when the internal pressure of the inner space H of the measuring section E is lower than a predetermined value, it can be determined, depending on the pressure necessary to reach the predetermined value, how many small fluid collecting sections are pressed. For example, all of the small fluid collecting sections 40, 41, and 42 are pressed when the internal pressure is considerably lower than the predetermined pressure, or only the fluid collecting section 40 is pressed when the internal pressure is slightly lower than the predetermined value. In this way, the second embodiment allows the internal pressure of the inner space H of the measuring section E to be finely adjusted. The fluid collecting section 43 disposed on the left side of the measuring section E does not have a plastic member on its upper surface, and does not have a function of artificially adjusting the internal pressure of the inner space H. For example, when all the small fluid collecting sections 40 to 42, each of which has a pressure adjusting function, are pressed to further reduce their inner spaces for pressure adjustment, air in the inner space H of the measuring section E does not easily flow into the fluid collecting sections 40 to 42 at the pressing of the measuring surface I with the finger F, and the functions of the fluid collecting sections 40 to 42 as the spaces for limiting the increase in pressure of the inner space H are lowered. Accordingly, the fluid collecting section 43 is provided as a space in which air in the inner space H flows when the measuring surface I is pressed with the finger to suppress the increase in pressure of the inner space H. This allows artificial pressure control and limitation of the increase in pressure of the inner space H to be performed in a well-balanced manner.

While the lower substrate 21 and the upper substrate 23 are separate in the embodiments shown in FIGS. 1 to 6, they may be integrally formed and bent to oppose each other, as shown in FIG. 2. In this case, the lower substrate 21 is made of a flexible film, in a manner similar to that of the upper substrate 23. Therefore, it is preferable that a reinforcing plate be disposed under the lower substrate 21, on which the measuring surface I is not provided, so that the lower substrate 21 is not bent by the pressing of the measuring surface I. Since the lower substrate 21 is flexible, a plastic member may be provided under a portion of the lower substrate 21 that defines the fluid collecting section 30 so that the fluid collecting section 30 can be collapsed from the lower side. In this case, the reinforcing plate may be made of, for example, a stainless steel plate, and the stainless steel plate may be partly subjected to plastic working to form the plastic member. It is satisfactory as long as the plastic member is provided on at least one of the upper and lower surfaces of the fluid collecting section 30.

A portion of the inner space H defined by the width T in FIG. 2 may function as a fluid collecting section.

The surface pressure distribution sensors shown in FIGS. 1 to 6 are fingerprint sensors, and are applicable to, for example, a portable-telephone owner authentication system. The surface pressure distribution sensors are also applicable to sensors other than the fingerprint sensors, for example, a sensor used to capture an imprint of a seal. This sensor can be used for various authentication operations and seal registration.

What is claimed is:

1. A surface pressure distribution sensor comprising:
a lower substrate;
a plurality of lower conductors arranged in parallel on an upper surface of the lower substrate;
a flexible upper substrate provided above the lower substrate with a predetermined space therebetween; and
a plurality of upper conductors arranged in parallel on a lower surface of the upper substrate so as to be orthogonal to the lower conductors,
wherein a measuring section having a first inner space is provided so that the upper conductors and the lower conductors oppose in a thickness direction therein,
wherein a fluid collecting section having a second inner space is disposed beside the measuring section,
wherein the surface pressure distribution is detected on the basis of an electrostatic capacitance changed by the pressing of a measuring surface provided on the upper substrate in the measuring section, and
wherein the first inner space of the measuring section communicates with the second inner space of the fluid collecting section.

2. The surface pressure distribution sensor according to claim 1, further comprising:
defining means provided between the lower substrate and the upper substrate; and
a space connecting section for connecting the first inner space of the measuring section and the second inner space of the fluid collecting section,
wherein the defining means defines a side wall of the first inner space, a side wall of the second inner space, and a wall of the space connecting section.

3. The surface pressure distribution sensor according to claim 1, further comprising:
a plastic member provided on at least one of upper and lower surfaces of the fluid collecting section,
wherein the fluid collecting section has a pressure adjusting function of artificially adjusting the internal pressure of the first inner space of the measuring section by pressing said at least one of the upper and lower surfaces having the plastic member to collapse the second inner space of the fluid collecting section.

4. The surface pressure distribution sensor according to claim 3, wherein the fluid collecting section includes a plurality of fluid collecting sections, and at least one of the fluid collecting sections has the pressure adjusting function.

5. The surface pressure distribution sensor according to any one of claims 1 to 4, wherein each of the first and second inner spaces is an air layer.
